(19) United States
(12) Patent Application Publication
(10) Pub. No.: US 2025/0038385 A1
(43) Pub. Date: Jan. 30, 2025

(54) FREQUENCY SELECTIVE SURFACE

(71) Applicant: Electronics and Telecommunications Research Institute, Daejeon (KR)

(72) Inventors: Jung Nam LEE, Sejong-si (KR); Jung Ick MOON, Daejeon (KR); Seung Keun PARK, Daejeon (KR)

(21) Appl. No.: 18/731,123

(22) Filed: May 31, 2024

(30) Foreign Application Priority Data
Jul. 25, 2023 (KR) 10-2023-0096898

(51) Int. Cl. H01P 1/20; H01P 3/08; H01Q 15/00

(52) U.S. Cl. CPC H01P 1/20; H01P 3/081; H01Q 15/0013

(57) ABSTRACT

A frequency selective surface (FSS) is provided. The FSS includes a dielectric having an arbitrary permittivity and a thickness, a loop gap including a gap and arranged on an upper surface of the dielectric, a patch arranged inside the loop gap, and a cross strip arranged on a lower surface of the dielectric.

### CROSS-REFERENCE TO RELATED APPLICATION

This application claims the benefit of Korean Patent Application No. 10-2023-0096898, filed on Jul. 25, 2023, in the Korean Intellectual Property Office, the entire disclosure of which is incorporated herein by reference for all purposes.

### BACKGROUND

### 1. Field of the Invention

One or more embodiments relate to a frequency selective surface (FSS), and more specifically, to an FSS having frequency characteristics of broadband in order to overcome a disadvantage of reducing the magnitude of a millimeter wave (mmWave) band signal incident from outdoors to indoors.

### 2. Description of the Related Art

The fifth-generation mobile communication system (a 5G system) is technology that is currently undergoing a lot of research. Expectations are rising for application of 5G technology in various fields, such as cross-reality technology for virtual reality/augmented reality/mixed reality and industrial/infrastructure advancement. The 5G system uses millimeter wave (mmWave), which has not been used before the fourth-generation mobile communication system (a 4G system), and introduces new technologies such as massive multiple-input and multiple-output (MIMO) beamforming using multiple antennas.

Accordingly, the 5G system can achieve ultra-high speed, high capacity, ultra-low latency, and high reliability. With the advent of the 5G system, further developments toward an advanced 5G system and the sixth-generation mobile communication system (a 6G system) are beginning in industry, academia, and governments, and higher frequencies including terahertz wavelength bands are being discussed.

However, as the frequency increases, there arise issues that may need to be solved. Since the mmWave has strong straightness of radio waves and has very short wavelengths, the mmWave is close to light, and accordingly, the radio waves cannot diffract but are absorbed and blocked due to the influence of obstacles. Therefore, in order to use the mmWave band for wireless communication, it is important to determine methods of preventing shadow areas caused by obstacles and expanding communication service coverage.

In the case of the mmWave band that is incident from outdoors to indoors, due to the issues described above, signals propagating indoors are almost lost by exterior walls and structures of a building, and most of the signals remaining after being lost propagate indoors through windows. However, the magnitude of the signals transmitted indoors through the windows decreases due to the difference in intrinsic impedance between free space and glass and transmission loss of the windows. The decreased magnitude of the signals causes shadow areas indoors and decreases signal quality and communication service coverage.

Accordingly, in order to overcome the decrease in the magnitude of signals and expand communication service coverage, there are issues that multiple mmWave band repeaters need to be installed indoors, which increases installation and operating costs.

### SUMMARY

Embodiments provide a device that may induce frequency passing characteristics of broadband by arranging a patch and a loop gap on an upper surface with respect to a dielectric and arranging a cross strip on a lower surface.

In addition, embodiments provide a device that may control opening and closing of a frequency band by arranging a PIN diode (a diode with a wide, undoped intrinsic semiconductor region between a p-type semiconductor and an n-type semiconductor region) between a patch and a microstrip line that is arranged to be spaced apart at an arbitrary interval from the patch arranged on an upper surface of a dielectric.

However, the technical aspects are not limited to the aforementioned aspects, and other technical aspects may be present.

According to an aspect, there is provided a frequency selective surface (FSS) including a dielectric having an arbitrary permittivity and a thickness, a loop gap including a gap and arranged on an upper surface of the dielectric, a patch arranged inside the loop gap, and a cross strip arranged on a lower surface of the dielectric.

A plurality of gap areas of the loop gap may be formed within the loop gap to face each other.

A gap area of the loop gap may be formed to be spaced apart at an equal interval within the loop gap.

The patch may be formed to be spaced apart at a predetermined interval from a loop area of the loop gap divided by a gap area of the loop gap.

The patch may be formed in a same number as a number of loop areas divided by the gap area.

The loop gap, the patch, and the cross strip may be formed in a mesh-type lattice structure using metal.

According to another aspect, there is provided an FSS including a dielectric having an arbitrary permittivity and a thickness, a loop gap including a gap and arranged on an upper surface of the dielectric, a patch arranged inside the loop gap, a cross strip arranged on a lower surface of the dielectric, a microstrip line spaced apart from the patch at a predetermined interval and arranged in a gap area of the loop gap, and a PIN diode arranged between the microstrip line and the patch.

When the PIN diode is in an off state, the dielectric may pass a signal in all operating frequency bands and when the PIN diode is in an on state, the dielectric may block a signal in all operating frequency bands.

A plurality of gap areas of the loop gap may be formed within the loop gap to face each other.

A gap area of the loop gap may be formed to be spaced apart at an equal interval within the loop gap.

The patch may be formed to be spaced apart at a predetermined interval from a loop area of the loop gap divided by a gap area of the loop gap.

The patch may be formed in a same number as a number of loop areas divided by the gap area.

The loop gap, the patch, the microstrip line, and the cross strip may be formed in a mesh-type lattice structure using metal.

Additional aspects of embodiments will be set forth in part in the description which follows and, in part, will be apparent from the description, or may be learned by practice of the disclosure.

According to an embodiment, frequency passing characteristics of broadband may be induced by arranging a patch and a loop gap on an upper surface with respect to a dielectric and arranging a cross strip on a lower surface.

In addition, according to an embodiment, a frequency may be used efficiently by controlling opening and closing of frequency band by arranging a PIN diode between a patch and a microstrip line that is arranged to be spaced apart at an arbitrary interval from the patch arranged on an upper surface of a dielectric.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIGS. 1A and 1B are diagrams illustrating a structure of a frequency selective surface (FSS), according to an embodiment;

FIG. 2 is a diagram illustrating a method of forming an FSS, according to an embodiment;

FIGS. 3A and 3B are diagrams illustrating characteristics of a reflection coefficient and a transmission coefficient of an FSS, according to an embodiment;

FIG. 4 is a diagram illustrating an electric field distribution of an FSS corresponding to a state of a PIN diode (a diode with a wide, undoped intrinsic semiconductor region between a p-type semiconductor and an n-type semiconductor region) or a radio frequency (RF) switch, according to an embodiment; and

FIGS. 5A and 5B are diagrams illustrating an application example of an FSS, according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments will be described in detail with reference to the accompanying drawings. When describing the embodiments with reference to the accompanying drawings, like reference numerals refer to like components and a repeated description related thereto will be omitted.

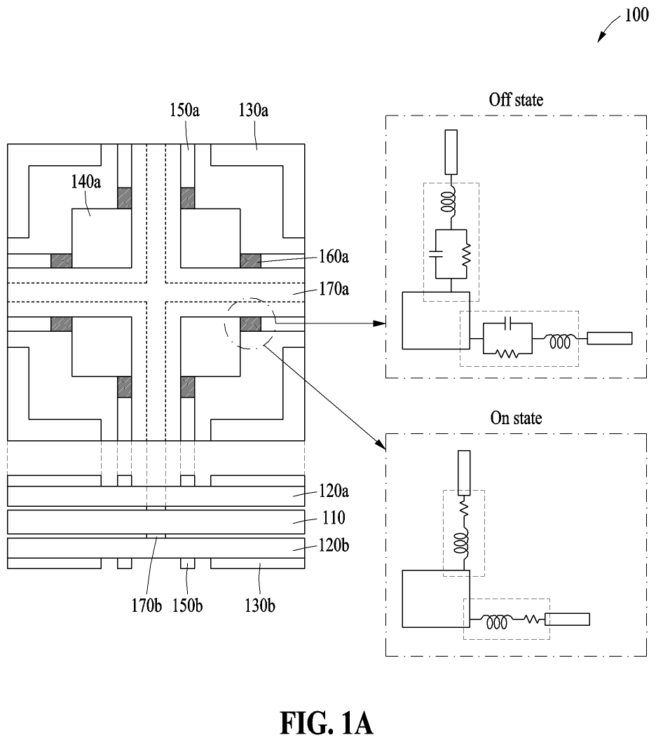

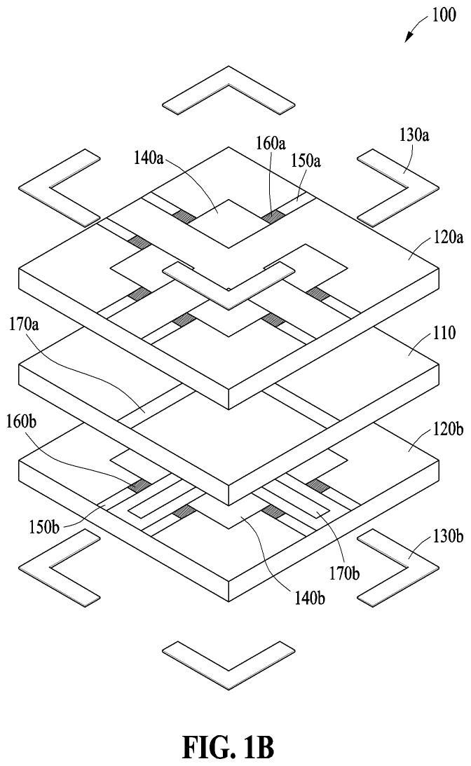

FIGS. 1A and 1B are diagrams illustrating a structure of a frequency selective surface (FSS), according to an embodiment.

Transparent intelligent surface (TIS) technology is technology of passing or reflecting a signal by periodically arranging an FSS of a mesh structure having a line width of micrometers (μm) on a transparent film.

This FSS may be a passive element that may selectively transmit or reflect electromagnetic waves within a specific frequency or frequency range and may include a metal pattern of a sub-wavelength size arranged on a thin dielectric substrate. Here, the resonance frequency and frequency response characteristics of the FSS may be determined by adjusting the size, shape, and interval of the metal pattern arranged on the dielectric substrate.

Therefore, the FSS may be designed to function as a filter for passing only electromagnetic waves of a specific frequency and blocking electromagnetic waves having frequencies other than the specific frequency. Alternatively, the FSS may also be designed to selectively attenuate or reflect electromagnetic waves of a specific frequency.

This FSS has an advantage of reducing size, weight, power consumption, and cost in that the FSS may selectively filter, attenuate, or reflect electromagnetic waves of a specific frequency without using an active element such as an amplifier or a filter.

FIG. 1A is a plan view and a side view of an FSS 100 according to an embodiment, and FIG. 1B is an exploded view of the FSS 100 according to an embodiment.

Referring to FIGS. 1A and 1B, the FSS 100 may include a first dielectric 110, second dielectrics 120a and 120b, loop gaps 130a and 130b, patches 140a and 140b, microstrip lines 150a and 150b, PIN diodes (diodes with a wide, undoped intrinsic semiconductor region between a p-type semiconductor and an n-type semiconductor region) 160a and 160b, and cross strips 170a and 170b.

More specifically, in the FSS 100, the second dielectrics 120a and 120b having an arbitrary permittivity and thickness may be attached to different surfaces of the first dielectric 110, respectively, that is transparent such as glass or acrylic on which electromagnetic waves are incident.

Here, when the second dielectrics 120a and 120b are attached to the first dielectric 110 that is transparent such as glass, a transparent film made of polyethylene terephthalate (PET) may be used for transparency. However, this type of the second dielectrics 120a and 120b is only an example and is not limited to the above example.

In the FSS 100, the loop gaps 130a and 130b including a gap may be arranged on upper surfaces of the second dielectrics 120a and 120b, respectively. More specifically, there may be a plurality of loop gaps 130a and 130b in which gap areas formed to face each other are spaced apart at an equal interval. Here, the loop gaps 130a and 130b may include metal such as silver (Ag) or copper (Cu) and may have a structure in which radio waves are transmitted through the inside of a loop. A frequency bandwidth to be passed or blocked may be determined based on a gap area width of the loop gaps 130a and 130b.

In the FSS 100, the patches 140a and 140b may be arranged inside the loop gaps 130a and 130b. Here, the patches 140a and 140b may be formed to be spaced apart at a predetermined interval from a loop area of the loop gaps 130a and 130b divided by a gap area. The number of patches (e.g., the patches 140a and 140b) may be formed in the same number as the number of loop areas of the loop gaps 130a and 130b divided by the gap area. Like the loop gaps 130a and 130b, the patches 140a and 140b may include metal such as Ag or Cu.

In the example of FIGS. 1A and 1B, the shape of the patches 140a and 140b is implemented as a square, but this shape of the patches 140a and 140b is only an example and is not limited to the above example.

In the FSS 100, the cross strips 170a and 170b in the shape of a cross may be arranged on lower surfaces of the second dielectrics 120a and 120b. Here, the cross strips 170a and 170b may also include metal such as Ag or Cu.

The FSS 100 provided by the present disclosure may induce capacitance through the loop gaps 130a and 130b arranged on the upper surfaces of the second dielectrics 120a and 120b and may induce coupling through the patches 140a and 140b arranged on the upper surfaces and the cross strips 170a and 170b arranged on the rear surfaces. Accordingly, a frequency bandwidth of electromagnetic waves that may pass through the first dielectric 110 may be expanded.

Furthermore, in the FSS 100, the microstrip lines 150a and 150b may be arranged in a gap area of the loop gaps 130a and 130b spaced apart from the patches 140a and 140b at a predetermined interval, and the PIN diodes 160a and 160b or radio frequency (RF) switches may be arranged between the microstrip lines 150a and 150b and the patches 140a and 140b.

Here, when the PIN diodes 160a and 160b or the RF switches are in an off state, the FSS 100 may pass a signal in all operating frequency bands through the first dielectric 110. That is, when the PIN diodes 160a and 160b or the RF switches are in the off state, the patches 140a and 140b and the microstrip lines 150a and 150b may be not connected to each other. Therefore, the FSS 100 may function as a band-pass filter with a wide bandwidth due to coupling between the loop gaps 130a and 130b and the patches 140a and 140b.

On the contrary, when the PIN diodes 160a and 160b or the RF switches are in an on state, the FSS 100 may block or reflect a signal in all operating frequency bands. That is, when the PIN diodes 160a and 160b or the RF switches are in the on state, the patches 140a and 140b and the microstrip lines 150a and 150b may be connected to each other. Therefore, the microstrip lines 150a and 150b between the loop gaps 130a and 130b may function properly and the FSS 100 may function as a band-stop filter.

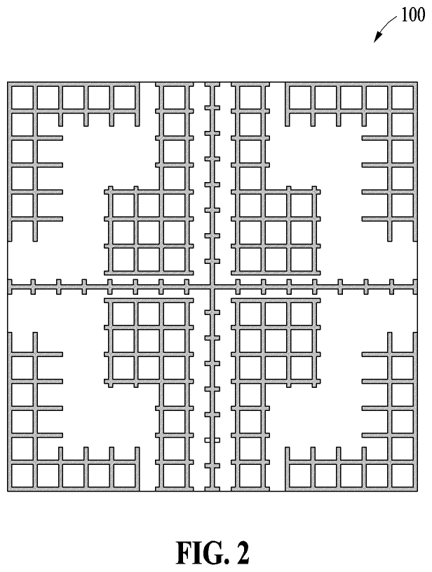

FIG. 2 is a diagram illustrating a method of forming an FSS, according to an embodiment.

Referring to FIG. 2, the FSS 100 of the present disclosure may include loop gaps, patches, microstrip lines, and cross strips that are arranged on upper and lower surfaces of a second dielectric and are formed in a mesh-type lattice structure having a line width of hundreds of um and a line interval of tens of um, in order to increase transparency. Accordingly, high transparency may be induced while maintaining conductivity.

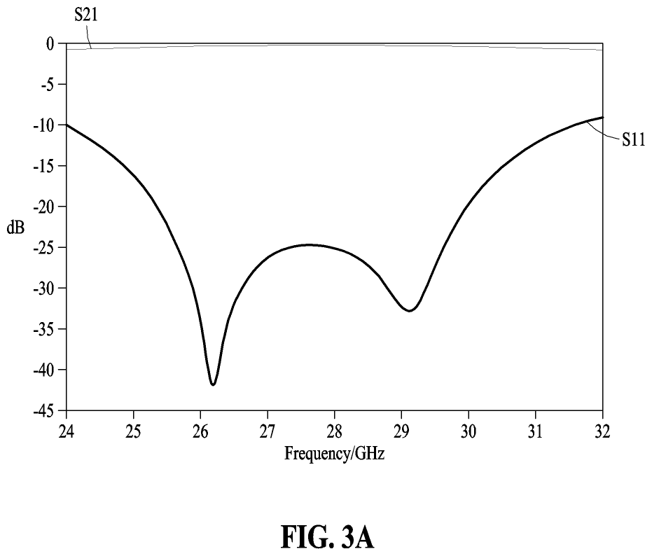

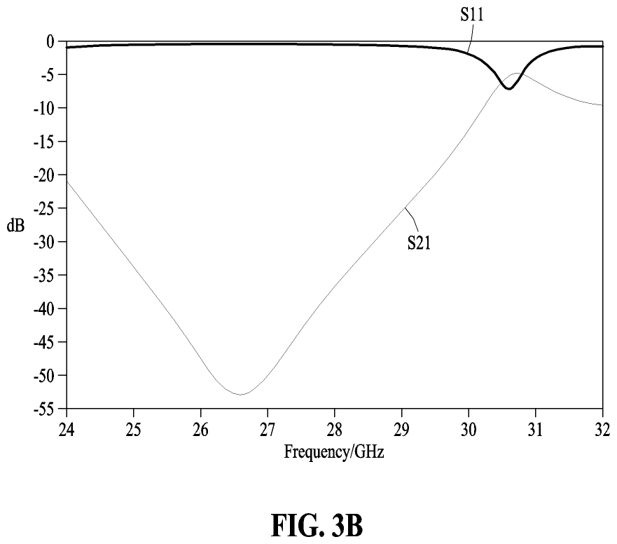

FIGS. 3A and 3B are diagrams illustrating characteristics of a reflection coefficient and a transmission coefficient of an FSS, according to an embodiment.

FIGS. 3A and 3B illustrate frequency characteristics according to an off/on state of a PIN diode or an RF switch. More specifically, FIG. 3A illustrates a reflection coefficient S11 and a transmission coefficient S21 when the PIN diode or the RF switch is in the off state, and FIG. 3B illustrates the reflection coefficient S11 and the transmission coefficient S21 when the PIN diode or the RF switch is in the on state.

Referring to FIG. 3A, when both the PIN diode or the RF switch are in the off state, a signal may be transmitted without attenuation in all operating frequency bands in an FSS of the present disclosure.

On the contrary, referring to FIG. 3B, when both the PIN diode or the RF switch are in the on state, the FSS of the present disclosure may block signals in all operating frequency bands, thereby using frequency more efficiently.

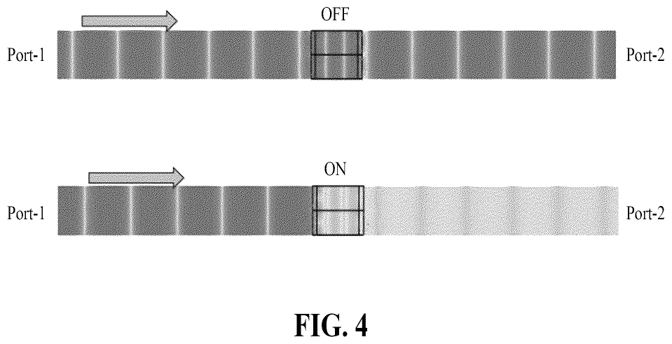

FIG. 4 is a diagram illustrating an electric field distribution of an FSS corresponding to a state of a PIN diode or an RF switch, according to an embodiment.

The upper part of FIG. 4 illustrates an electric field distribution of the FSS when the PIN diode or the RF switch is in an off state. When the PIN diode or the RF switch on the FSS is in the off state, it may be confirmed that a signal passes normally.

On the contrary, the lower part of FIG. 4 illustrates an electric field distribution of the FSS when the PIN diode or the RF switch is in an on state. When the PIN diode or the RF switch on the FSS is in the on state, it may be confirmed that a signal is blocked or reflected.

In other words, the FSS provided by the present disclosure may pass signals without attenuation in all operating frequency bands due to ultra-wideband characteristics when the PIN diode or the RF switch is in the off state and may block signals when the PIN diode or the RF switch is in the on state.

Therefore, the FSS of the present disclosure may be attached to a location where signal attenuation occurs, in order to improve signal quality and minimize shadow areas. In addition, the FSS may also be applied to application fields aimed at preventing wiretapping and shielding frequency to block signals.

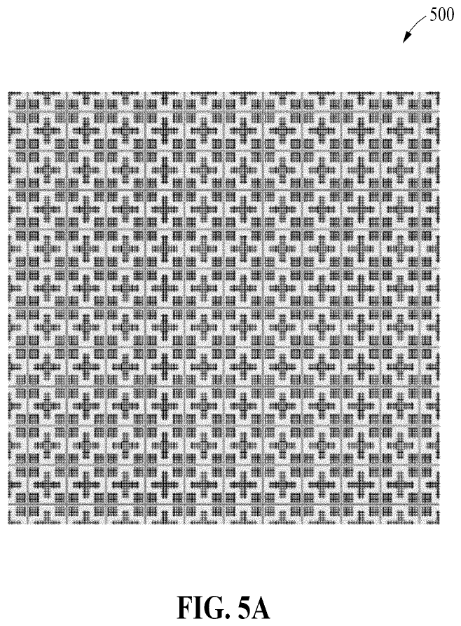

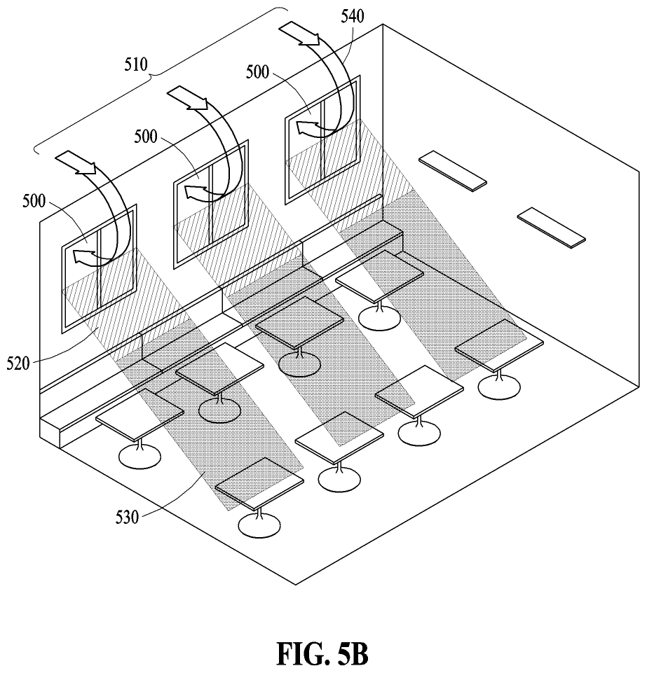

FIGS. 5A and 5B are diagrams illustrating an application example of an FSS, according to an embodiment.

FIG. 5A illustrates an FSS arrangement 500, which is a result of arranging an FSS provided by the present disclosure according to the window size, and FIG. 5B illustrates signal characteristics when the FSS arrangement 500 is placed on indoor windows.

Referring to FIG. 5B, when signals 510 are incident to a room from outside through the windows and there are only typical windows, an indoor reach distance 520 of radio waves is very short, and therefore, radio wave shadow areas may occur.

Here, when the FSS arrangement 500 provided by the present disclosure is attached to the windows, an indoor reach distance 530 of radio waves may be increased, and therefore, the radio wave shadow areas may be eliminated.

In addition, when it is required to block the signals 510 incident to the room through the windows, a PIN diode or an RF switch on an FSS included in the FSS arrangement 500 may be turned on to block the signals 510 by making reflections 540 of the signals 510.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A frequency selective surface (FSS) comprising:
a dielectric having an arbitrary permittivity and a thickness;
a loop gap including a gap and arranged on an upper surface of the dielectric;
a patch arranged inside the loop gap; and
a cross strip arranged on a lower surface of the dielectric.

2. The FSS of claim 1, wherein
a plurality of gap areas of the loop gap is formed within the loop gap to face each other.

3. The FSS of claim 1, wherein
a gap area of the loop gap is formed to be spaced apart at an equal interval within the loop gap.

4. The FSS of claim 1, wherein
the patch is formed to be spaced apart at a predetermined interval from a loop area of the loop gap divided by a gap area of the loop gap.

5. The FSS of claim 4, wherein
the patch is formed in a same number as a number of loop areas divided by the gap area.

6. The FSS of claim 1, wherein
the loop gap, the patch, and the cross strip are formed in a mesh-type lattice structure using metal.

7. A frequency selective surface (FSS) comprising:
a dielectric having an arbitrary permittivity and a thickness;
a loop gap including a gap and arranged on an upper surface of the dielectric;
a patch arranged inside the loop gap;
a cross strip arranged on a lower surface of the dielectric;
a microstrip line spaced apart from the patch at a predetermined interval and arranged in a gap area of the loop gap; and
a PIN diode (a diode with a wide, undoped intrinsic semiconductor region between a p-type semiconductor and an n-type semiconductor region) arranged between the microstrip line and the patch.

8. The FSS of claim 7, wherein,
when the PIN diode is in an off state, the dielectric passes a signal in all operating frequency bands and when the PIN diode is in an on state, the dielectric blocks a signal in all operating frequency bands.

9. The FSS of claim 7, wherein
a plurality of gap areas of the loop gap is formed within the loop gap to face each other.

10. The FSS of claim 7, wherein
a gap area of the loop gap is formed to be spaced apart at an equal interval within the loop gap.

11. The FSS of claim 7, wherein
the patch is formed to be spaced apart at a predetermined interval from a loop area of the loop gap divided by a gap area of the loop gap.

12. The FSS of claim 11, wherein
the patch is formed in a same number as a number of loop areas divided by the gap area.

13. The FSS of claim 7, wherein
the loop gap, the patch, the microstrip line, and the cross strip are formed in a mesh-type lattice structure using metal.
